(19) United States
(12) Patent Application Publication
(10) Pub. No.: US 2016/0375819 A1
(43) Pub. Date: Dec. 29, 2016

(54) Pick Up Springboard

(71) Applicant: Sharon L. Camp, Brooklyn, OH (US)

(72) Inventor: Sharon L. Camp, Brooklyn, OH (US)

(21) Appl. No.: 14/749,681

(22) Filed: Jun. 25, 2015

(51) Int. Cl. B60P 7/14

(52) U.S. Cl. CPC B60P 7/14

(57) ABSTRACT

A load retaining gate assembly is provided to restrain the movement of the items stored in the bed of a vehicle. The load retaining gate assembly is made of two gate members that are arranged in a sliding relationship with the help of at least one spring-loaded assembly. One gate member slides into another gate member to extend the length of the load retaining gate assembly to position the load retaining gate assembly against the sidewalls of the vehicle bed in an extended position. In extended position the load retaining gate assembly is held in place by the pressure put by the spring against the two sidewalls of the vehicle bed. The load retaining gate assembly can be positioned anywhere across the length of the vehicle bed and can be removed from its position when not needed.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

Field of Invention

The present invention generally relates to a load retaining device. More particularly, the present invention relates to “a load retaining gate assembly that is made of two spring loaded gate members that are positioned against the side walls of the vehicle bed to restrain the movement of the items stored therein. The load retaining gate assembly can be positioned anywhere across the length of the vehicle bed and removed when not in use.”

Background of Invention

Pick-up trucks, SUVs, vans and other vehicles are commonly used to transport different kind of items. Such items may include purchased grocery items, furniture, vegetables, etc. These items, which are stored in the vehicle bed, commonly spill out and spread to different locations in the vehicle bed while driving the vehicle. It is very troublesome for the person to climb in the vehicle bed and retrieve the spilled items from the vehicle bed.

To avoid this inconvenience, different systems have been developed to keep the stored items in their place in the vehicle bed. In general, a tie down assembly or a rectangular load bed divider is placed in the vehicle bed to restrain the stored items in place. For example, U.S. Pat. No. 5,385,435 A, issued to Frederick A. Musta on Jan. 31, 1995, discloses a tie down system for securing articles to a load bearing structure during transportation. However, this and other tie-down systems cannot secure articles of all sizes. Furthermore, it can be secured in only specific positions in the vehicle where the tie down structure is available. Similarly, U.S. Pat. No. 5,253,913 A, issued to William F. Baker on Oct. 16, 1993, discloses a rectangular shaped truck bed partition consisting of mounting members for mounting a cargo cage to truck bed. The cargo cage retains the stored items. This cargo cage can be positioned in only one specific position in the vehicle bed. Another invention, U.S. Pat. No. 6,629,807 B2, issued to Roll-N-Lock on Oct. 7, 2003, discloses rectangular shaped load retaining devices that can be positioned anywhere along the length of the vehicle bed. Another invention, U.S. Pat. No. 5,427,486 A, issued to Gerald D. Green on Jun. 27, 1995, discloses rectangular shaped load retaining device that can be extended in width to fit the vehicle bed, as well as can be positioned anywhere along the length of the vehicle bed.

These load retaining devices suffer from the different types of issues. Some of these load retaining devices cannot be easily detached from their position in the vehicle bed when they are not in use. Many of these load retaining devices, such as net structured load retaining devices, do not secure small items well, which spill through the openings in the net. Also, most of these load retaining devices cannot be easily positioned anywhere along the length of the vehicle bed.

It is an aspect of the invention to overcome or alleviate a problem of the prior art.

This permits the use of the present invention, which enhances the prior art of the load retaining devices. The present invention may be positioned anywhere along the length of the vehicle bed to retain stored articles of all sizes, including small items and allow easy removal of the load retaining device when it is not in use.

### BRIEF SUMMARY OF THE INVENTION

In view of the foregoing, one aspect of the various disclosed embodiments of the present invention is to provide a load retaining gate assembly that is made of two spring loaded gate members that are positioned against the side walls of the vehicle bed to restrain the movement of the items stored therein. The load retaining gate assembly can be positioned anywhere across the length of the vehicle bed. It can be removed when not in use.

Preferably, the load retaining gate assembly addresses, or at least ameliorates, one or more of the problems described above. To this end, the present invention, related to a load retaining gate assembly with some unique aspects, is disclosed.

Accordingly, it is a primary objective of the present invention to provide a load retaining gate assembly that is positioned against the side walls of the vehicle bed to restrain the movement of the items stored therein. The load retaining gate assembly is made of two spring loaded gate members. The load retaining gate assembly can be positioned anywhere across the length of the vehicle bed, and then removed from its position in the vehicle bed when not in use.

It is yet another objective of the present invention that the load retaining gate assembly can be stored in a compressed position when it is not in use.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure and the appended claims. For a better understanding of the invention, its operating advantages, and the specific objectives attained by its uses, reference should be made to the accompanying drawings, descriptive matter, and the appended claims, in which there are illustrated preferred embodiments of the invention.

### BRIEF DESCRIPTION OF THE SEVERAL VIEWS OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 is a perspective view of a load retaining gate assembly for a ½ ton truck, according to the preferred embodiment of the present invention.

FIG. 2 is a front perspective view of a load retaining gate assembly for a ¾ ton truck, according to the preferred embodiment of the present invention.

### DETAILED DESCRIPTION OF THE INVENTION

The following detailed description of the present invention enables the teaching of the invention and its best, currently known embodiment. Those skilled in the art can understand that many changes can be made in the embodiments described, while still obtaining beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made, may be desired in certain circumstances, and are part of the present invention. Thus, the following description is provided as illustrative of the principle of the present invention.

Provided herein are systems for restraining the movement of items that are stored in the vehicle bed with a load retaining gate assembly.

Embodiments of the present invention provide a load retaining gate assembly that is made of two spring loaded gate members that are positioned against the side walls of the vehicle bed to restrain the movement of the items stored therein. The load retaining gate assembly can be positioned anywhere across the length of the bed of the vehicle. Furthermore, the load retaining gate assembly can be removed from its position for storage when it is not in use. Accordingly, the specific configurations described herein are illustrative only, and are not intended to represent an exhaustive list of all possible configurations or designs of the present invention. The present invention has been described herein in respect to a truck. However, the inventive concepts described herein are applicable to any pick-up truck, SUV, van, or other vehicle that stores items in its bed.

Embodiments of the method are shown in the figures and discussed below, and it should be understood that the operations, as presented, are exemplary, and that some operations may be substituted, added, rearranged, or removed while still encompassing the inventive subject matter. Moreover, it should be understood that the order of operations is not to be limited, unless explicitly specified herein.

Aspects of the present inventive subject matter are described with reference to the figures provided herein.

The present invention provides a load retaining gate assembly to restrain the movement of the items that are stored in the bed of a vehicle. The stored items may be groceries or other purchased items. The load retaining assembly restricts the movement of all of the stored articles, including small items. Hence, the person does not need to dive in the vehicle towards front of the vehicle to collect the stored item which may have spilled over during driving the vehicle. The load retaining gate assembly is made of two gate members that are arranged in a sliding relationship with the help of at least one spring loaded assembly. One gate member slides into another gate member to extend the length of the load retaining gate assembly to position the load retaining gate assembly against the side walls of the vehicle bed in an extended position. As one gate members slides into another gate member with help of the spring loaded assembly, the length of the load retaining gate assembly can be adjusted to different sizes according to the width of the vehicle bed. The two gate members are rectangular shaped. It is preferred that one gate member is longer than the other gate member. Each of the at least one spring loaded assembly is made up of a spring that is attached to the long gate member. This passes through a tube in the small gate member. The two ends of a spring are threaded into an eyelet. It is preferable that the load retaining gate assembly has two spring loaded assemblies. When the load retaining gate assembly is in extended position, the spring puts pressure against the two side walls of the vehicle bed to hold the load retaining gate assembly in place. It is preferred that the load retaining gate assembly also has a holding means for handling the load retaining gate assembly while it is set up in extended position against the side walls of the vehicle bed or removed from this position. The load retaining gate assembly can be positioned anywhere across the length of the vehicle bed. When the load retaining gate assembly is not required to restrain any item in the vehicle bed, it can be removed from its position.

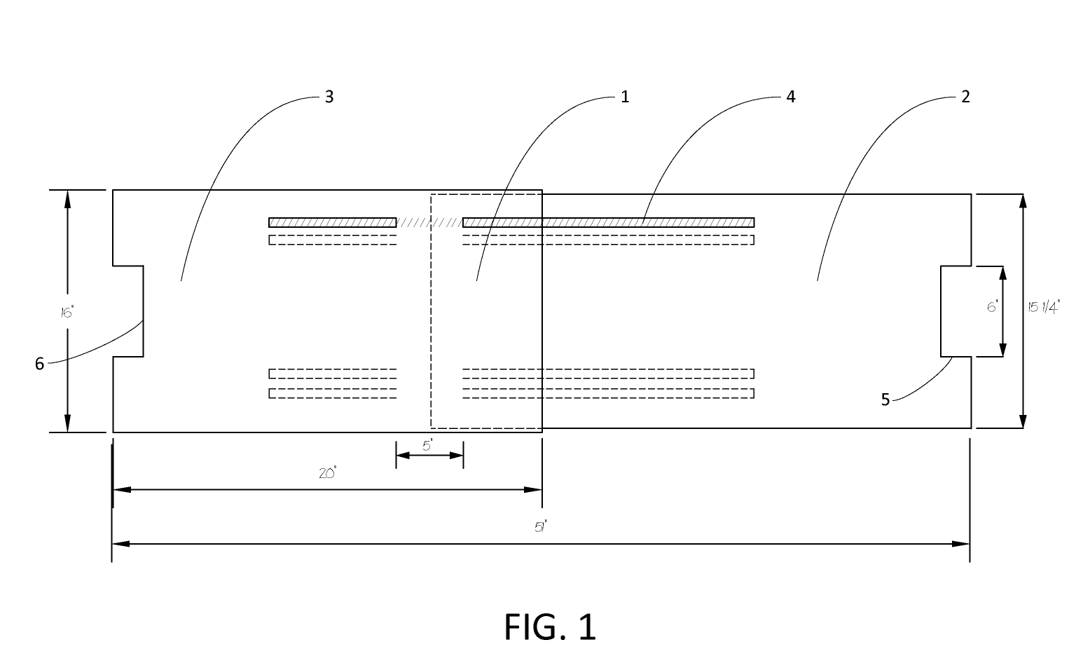

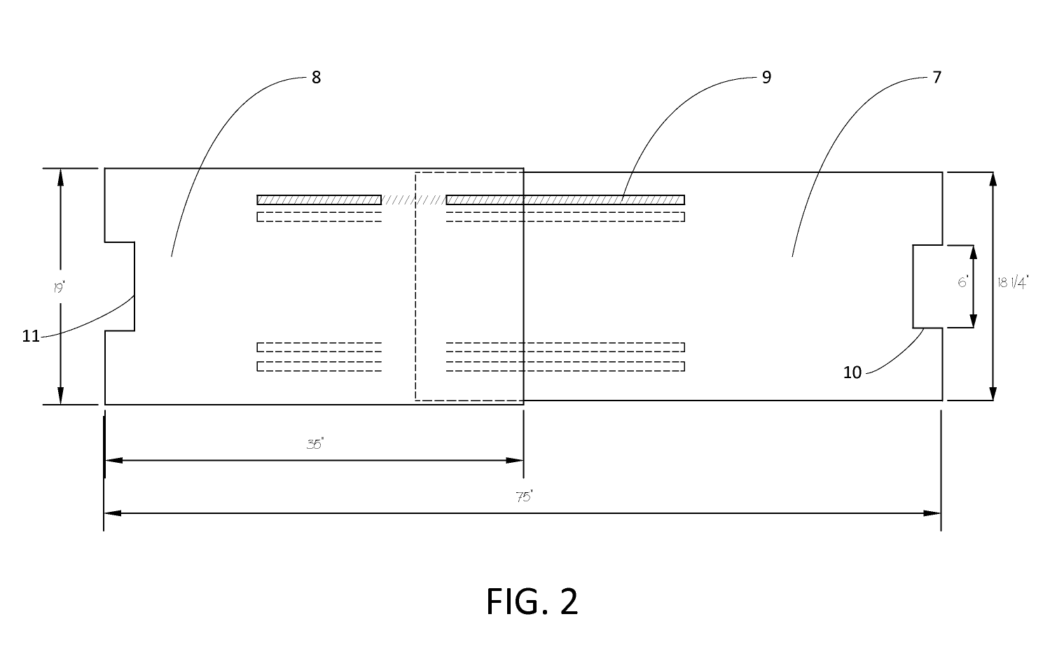

Thus, in accordance with a preferred embodiment of the present invention, and in reference to FIGS. 1 and 2, the load retaining gate assembly 1 is made of a long gate member 2 and a small gate member 3. As shown in the figures, the spring loaded assembly 4 has a spring that is attached to the long gate member 2 and passes through a tube in the small gate member 3. The outer side of the long gate member has a cut region 5 in the middle. Similarly, the outer side of the small gate member has a cut region 6 in the middle. These cut regions 5 and 6 are for placing hands to handle the load retaining gate assembly when it is set up in extended position against the side walls of the vehicle bed or removed from this position.

The load retaining gate assembly can be available in multiple shapes, sizes, thicknesses, and/or colors for use with different types of vehicles. The weight of the load retaining gate assembly would preferably be 10 pounds. Again, referring to FIG. 1 for a ½ ton truck, the long gate member 2 of the load retaining gate assembly is 31 inches long and 15.75 inches wide. The small gate member 3 of the load retaining gate assembly is 20 inches long and 16 inches wide. When placed in an extended position, the load retaining gate assembly is 51 inches long. The cut regions are rectangular shaped, with 6 inches in length and 2 inches in width. Also, as shown in FIG. 2 for a ¾ ton truck, the long gate member 7 of the load retaining gate assembly is 40 inches long and 18.75 inches wide. The small gate member 8 of the load retaining gate assembly is 35 inches long and 19 inches wide. When placed in an extended position, the load retaining gate assembly is 75 inches long. As shown in the figures, the spring loaded assembly 9 has a spring that is attached to the long gate member 7 and passes through a tube in the small gate member 8. The cut regions 10 and 11 are rectangular shaped, with 6 inches in length and 2 inches in width.

The gate members of the load retaining gate assembly are made of a resilient and lightweight material, such as polymer material or other similar materials. It is preferred that the gate members are made of plastic. The eyelet is also preferably made of plastic. However, in accordance with various alternate embodiments, the load retaining gate assembly could be substituted with alternative materials.

In another embodiment of the present invention, the load retaining gate assembly can be removed from its position in the vehicle bed and stored in a compressed position. The load retaining gate assembly has a fastening means to change it to its compressed position. The fastening means may be preferably hook and riveted post, or latch and riveted post. However, other types of fastening means may also be used. One latch may be placed preferably at 6 inches from the top edge and one latch at 6 inches from the bottom edge of one gate member. The riveted posts may be positioned in alignment with the latches on the second gate member. The fastening means keep the gate compressed while not being used. The load retaining gate assembly may be stored in the compressed position.

In a preferred embodiment of the present invention, and in reference to FIG. 1, a method of using the load retaining gate assembly to restrain the movement of the items stored in the truck bed is provided. To position the load retaining gate assembly in the vehicle bed, the load retaining gate assembly in its compressed position is placed in the vehicle bed with the outer edge of one gate member placed against one side wall of the vehicle bed. The load retaining gate assembly is released from its compressed position by unlatching one gate member from another gate member. This releases another gate member to allow the spring of the spring loaded assembly 16 to push another gate member to be positioned against the other side wall of the vehicle bed. The hands may be placed in the cut regions to handle the load retaining gate assembly while setting it up. The load retaining gate assembly may be positioned anywhere along the length of the vehicle bed depending on how many items are needed to be retained. When not in use the load retaining gate assembly can be taken out from its position in the vehicle bed. To remove the load retaining gate assembly, a hand is placed in the cut region, and one gate member is pulled along the length of the load retaining gate assembly to slide it into another gate member and bringing a latch in alignment with its corresponding riveted post. This reduces the length of the load retaining gate assembly. The latch is then locked in its corresponding riveted post to secure the load retaining gate assembly in the compressed position.

It is to be understood that the above description is intended to be illustrative, and not restrictive. For example, the above discussed embodiments may be used in combination with each other. Many other embodiments will be apparent to those of skill in the art upon reviewing the above description.

Plural instances may be provided for components, operations, or structures described herein as a single instance. Finally, boundaries between various components, operations, and elements are somewhat arbitrary, and particular operations are illustrated in the context of specific illustrative configurations. Other allocations of functionality are envisioned, and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter. The scope of the invention is, therefore, indicated by the appended claims rather than by the foregoing description. All changes that come within the meaning and range of equivalency of the claims are to be embraced within their scope.

I claim:

1. A load retaining gate assembly for positioning a bed against the side walls of a vehicle to restrain the movement of the items stored therein, the load retaining gate assembly comprising:
A first gate member;
A second gate member with a tube; and
at least one spring loaded assembly coupling said two gate members in a sliding relationship with each other.

2. The load retaining gate assembly of claim 1, wherein the load retaining gate assembly exists in art extended position and a compressed position.

3. The load retaining gate assembly of claim 1, wherein said first gate member slides into said second gate member to extend the length of the load retaining gate assembly.

4. The load retaining gate assembly of claim 1, wherein said first and said second gate members are rectangular shaped.

5. The load retaining gate assembly of claim 1, wherein said first gate member is longer than said second gate member.

6. The load retaining gate assembly of claim 1, wherein said spring loaded assembly is comprised of a spring attached to said first gate member and passing through said tube in said second gate member.

7. The load retaining gate assembly of claim 6, herein the two ends of said spring are threaded into an eyelet.

8. The load retaining gate assembly at claim 7, wherein said eyelet is made of plastic.

9. The load retaining gate assembly of claim 1, wherein the load retaining gate assembly comprises of two spring loaded assemblies.

10. The load retaining gate assembly of claim 1 further comprises a holding means fat handling said load retaining gate assembly while it is set an in extended position against the side walls of the vehicle bed or removed from the vehicle bed.

11. The load retaining gate assembly of claim 10, wherein said holding means is a cut region in the middle of the outer side of the two gate members for placing hand while handling said load retaining gate assembly.

12. The load retaining gate assembly of claim 1 further comprises of a releasable fastening means for holding said load retaining gate assembly in compressed position

13. The load retaining gate assembly of claim 12, wherein said releasable fastening means comprises of a latch attached to said first gate member and a riveted post attached to said second gate member positioned in alignment with the latch to receive the latch.

14. The load retaining gate assembly of claim 12, wherein said releasable fastening means comprises of a hook attached to said first gate member and a riveted post attached to said second gate member positioned in alignment with the hook to receive the hook.

15. The load retaining gate assembly of claim 1, wherein said first and said second gate members are made of a resilient and light weight material.

16. The load retaining gate assembly of claim 14, wherein said first and said second gate members of said load retaining gate assembly is made of plastic.

17. (canceled)

18. (canceled)

19. (canceled)

20. (canceled)

21. (canceled)
